(19) United States
(12) Patent Application Publication
(10) Pub. No.: US 2017/0125891 A1
(43) Pub. Date: May 4, 2017

(54) ANTENNA

(71) Applicant: KABUSHIKI KAISHA TOSHIBA, Tokyo (JP)

(72) Inventor: Sema DUMANLI OKTAR, Bristol (GB)

(21) Appl. No.: 15/125,110

(22) PCT Filed: May 28, 2014
(86) PCT No.: PCT/GB2014/051621

§ 371 Date: Sep. 9, 2016

(51) Int. Cl. H01Q 1/27; H01Q 3/26; H01Q 1/36; H01Q 9/04; H01Q 1/48; H01Q 3/24

(52) U.S. Cl. CPC H01Q 1/273; H01Q 1/48; H01Q 3/24; H01Q 1/36; H01Q 9/0428; H01Q 3/26

(57) ABSTRACT

In an embodiment, an antenna (10) comprises a planar patch radiator having a first excitation point (21) and a second excitation point (22); a ground plane (14); and a feed line (30) configured to couple an input signal to the first excitation point and the second excitation point such that the relative phase between the input signal at the first excitation point and the input signal at the second excitation point is switchable between a first relative phase and a second relative phase and the antenna radiates in a first mode in response to the first relative phase and the antenna radiates in a second mode in response to the second relative phase.

### FIELD

Embodiments described herein relate generally to antennas and in particular to antennas having switchable modes of radiation.

### BACKGROUND

A body area network (BAN) is a wireless network of wearable devices. A typical body area network includes a number of sensors worn by, or implanted in, a patient which monitor the patient's vital signs. The information gathered by the sensors may be collected by a relay device, also worn by the patient, and transmitted to an external processing unit.

On body antenna design is a challenging task due to the body being in the near-field of the antenna and the interaction between the two. The antenna should be designed to have a more application dependent gain pattern and to be less sensitive to near field effects of the body. For the case of on-body links, the antenna radiation should be directed along the body (omni-directional in horizontal plane) preferably with vertical polarization in addition to antenna being conformal to the body. For the case of off-body links, the antenna radiation should be directed away from the body while polarisation is not as critical as the on-body case.

### BRIEF DESCRIPTION OF THE DRAWINGS

FIG. 1 shows an antenna according to an embodiment;

FIG. 2a shows an antenna according to an embodiment when operating in a first mode;

FIG. 2b shows a radiation pattern of an antenna according to an embodiment when operating in a first mode;

FIG. 3a shows an antenna according to an embodiment when operating in a second mode;

FIG. 3b shows a radiation pattern of an antenna according to an embodiment when operating in a second mode;

FIGS. 4a to 4f show the results of parametric analysis to optimise dimensions of an antenna according to an embodiment;

FIG. 5 shows a body area network including an antenna according to an embodiment; and

FIG. 6 shows the reflection coefficient and frequency for an antenna according to an embodiment.

### DETAILED DESCRIPTION

In an embodiment, an antenna comprises a planar patch radiator having a first excitation point and a second excitation point; a ground plane; and a feed line configured to couple an input signal, to the first excitation point and the second excitation point such that the relative phase between the input signal at the first excitation point and the input signal at the second excitation point is switchable between a first relative phase and a second relative phase and the antenna radiates in a first mode in response to the first relative phase and the antenna radiates in a second mode in response to the second relative phase.

In an embodiment, the feed line comprises a first branch coupled to the first excitation point; a second branch coupled to the second excitation point; and a switchable element configured to switch the feed line between a first configuration and a second configuration, wherein in the first configuration there is a first path difference between the first branch and the second branch and in the second configuration there is a second path difference between the first branch and the second branch.

In an embodiment in the first configuration, the first mode is resonant at a frequency within an operating frequency band, whereas the second mode is resonant at a frequency outside the operating frequency band, and in the second configuration, the second mode is resonant at a frequency within the operating frequency band, whereas the second mode is resonant at a frequency outside the operating frequency band, thereby forcing operation of the antenna in a mode dependent on configuration.

In an embodiment, the ground plane is arranged between the planar patch radiator and the feed line.

In an embodiment, the antenna further comprises a first feeding pin connected to the first excitation point and a second feeding pin connected to the second excitation point, wherein the first feeding pin passes through a first slot in the ground plane and couples to the feed line and the second feeding pin passes through a second slot in the ground plane and couples to the feed line.

In an embodiment, the first mode is an omni-directional mode in which the antenna radiates in the plane of the planar radiator and the second mode is a directive radiation mode in which the antenna radiates normal to the plane of the planar radiator.

In an embodiment, the first excitation point and the second excitation point are symmetrical in the plane of the planar radiator.

In an embodiment, the planar patch radiator and/or the ground plane is rectangular.

In an embodiment, the size of the antenna in the plane of the planar radiator is less than 0.5 wavelengths of the input signal at the operating frequency by less than 0.5 wavelengths of the input signal at the operating frequency.

In an embodiment, the planar patch radiator is rectangular and the sides of the planar patch radiator have a dimension in the range is 0.42 wavelengths of the input signal at the operating frequency to 0.34 wavelengths of the input signal at the operating frequency.

In an embodiment, the planar patch radiator and/or the ground plane is circular.

In an embodiment, the planar patch radiator is circular and has a diameter in the range 0.47 wavelengths of the input signal at the operating frequency to 0.40 wavelengths of the input signal at the operating frequency.

In an embodiment, the antenna is configured for use in a body area network, wherein the first mode is an on body mode and the second mode is an off body mode.

In an embodiment, the first relative phase generates a phase difference of less than 90 degrees and the second relative phase generates a phase difference of greater than 90 degrees.

In an embodiment, the switchable element comprises a PIN diode, a MEMS switch or a MOSFET switch.

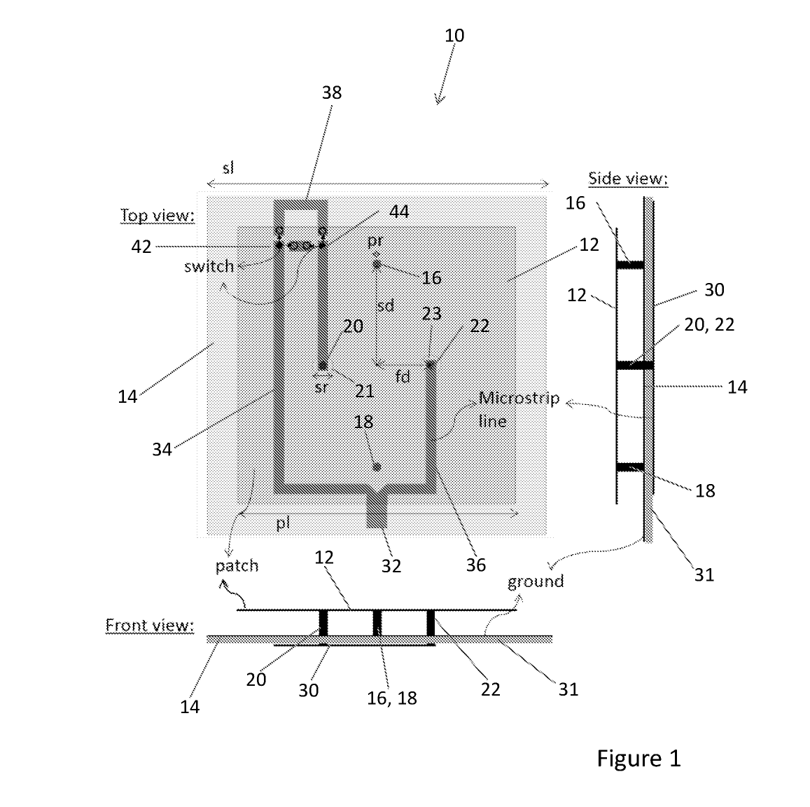

FIG. 1 shows an antenna according to an embodiment. The antenna 10 has a conductive radiating plane 12 and a grounded conductive ground plane 14. In the embodiment shown, the radiating plane 12 and the ground plane 14 are both square. The radiating plane 12 and the ground plane 14 are located parallel to one another and separated by a distance h1. The radiating plane 12 has sides of a dimension pl and the ground plane 14 has sides of a dimension sl. In the embodiment shown in FIG. 1, the ground plane 14 is larger than the radiating plane 12. The centre of the radiating plane 12 is located above the centre of the ground plane 14. The ground plane 14 extends beyond the radiating plane 12 by an equal amount at each side of the antenna 10.

The radiating plane 12 is electrically connected to the ground plane 14 by two shorting pins 16 & 18. The shorting pins are arranged at locations which are symmetrical with respect to the centre of the radiating plane 12. The centres of the radiating plane 12 and the ground plane 14 are on the same axis. A first shorting pin 16 and a second shorting pin 18 are located on a first axis of symmetry of the radiating plane 12 which is normal to the sides of the radiating plane 12. The shorting pins have a radius pr and are located a distance sd from the centre of the radiating plane.

Two feeding pins are connected to the radiating plane 12. A first feeding pin 20 and a second feeding pin 22 are located on a second axis of symmetry of the radiating plane 12 which is normal to the sides of the radiating plane 12 and normal to the first axis of symmetry. The ground plane has a first circular slot 21 and a second circular slot 23. The first feeding pin 20 passes through the first slot 21. The second feeding pin 22 passes through the second slot 23. The slots each have a radius of sr which is greater than the radius pr of the feeding pins. The first feeding pin 20 and the second feeding pin 22 are each located a distance of fd from the centre of the radiating plane 12.

A microstrip feed line 30 is arranged beneath the ground plane 14. A substrate of thickness h2 separates the feed line 30 from the ground plane 14. The feed line 32 starts at a connection point 32 which is attached to a connector. The connector may be implemented as an SMA connector includes a connection to the feed line and a ground connection to the ground plane. The feed line 30 has a T-junction at which it splits into a first branch 34 and a second branch 36. The first branch 34 connects to the third first feeding pin 20 and the second branch 36 connects to the second feeding pin 22. The first feeding pin 20 and the second feeding pin 22 extend through the substrate to connect with the feed line 30.

The first branch 34 of the feed line 30 includes two paths to the first feeding pin 20. A first switch 42 and a second switch 44 are located on the first branch 34 of the feed line 30 and control whether a long section 38 or a short section 40 forms part of the first branch 34. Thus the path length of the first branch 34 is switchable between a first path length including the long section 38 and a second path length including the short section 40.

The first switch 42 and the second switch 44 may be implemented as PIN diodes, MEMS (Microelectromechanical Systems) switches, or MOSFET switches.

The size of the antenna 10 shown in FIG. 1 is less than 0.5λ by 0.5λ, where λ is the wavelength of the radiation emitted and received by the antenna. The lengths of the first branch 34 and the second branch 36 of the feed line are selected so that there is a phase difference between the signal applied to a first excitation point corresponding to the first feeding pin 20 and the signal applied to a second excitation point corresponding to the second feeding pin 22.

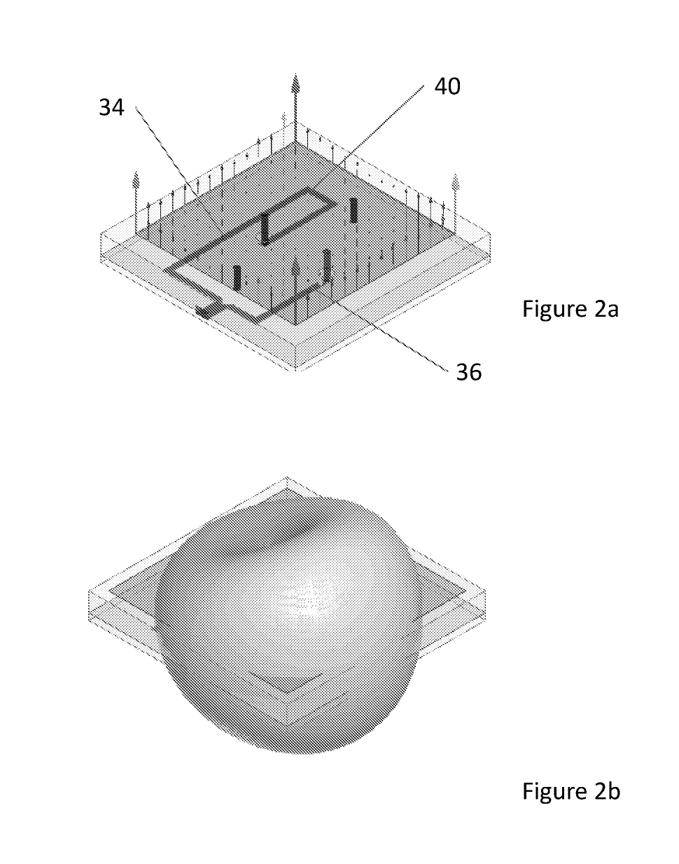

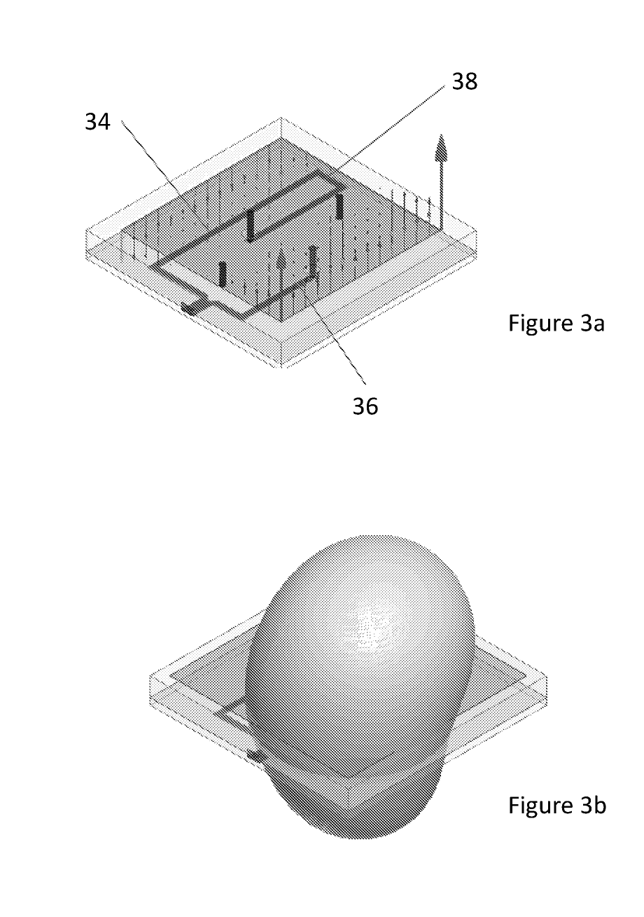

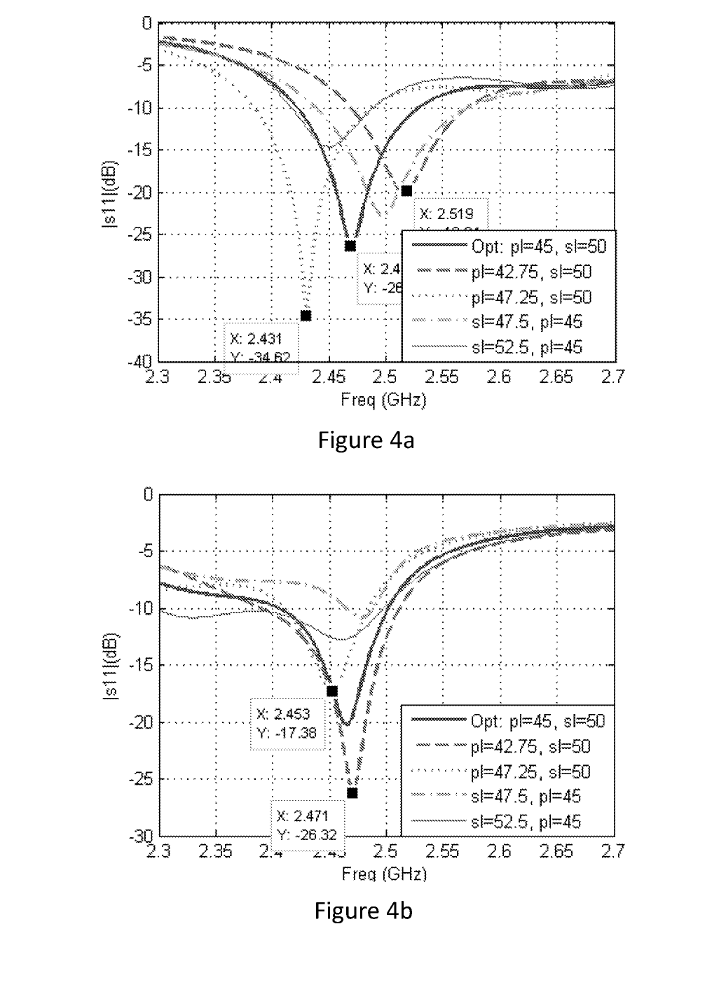

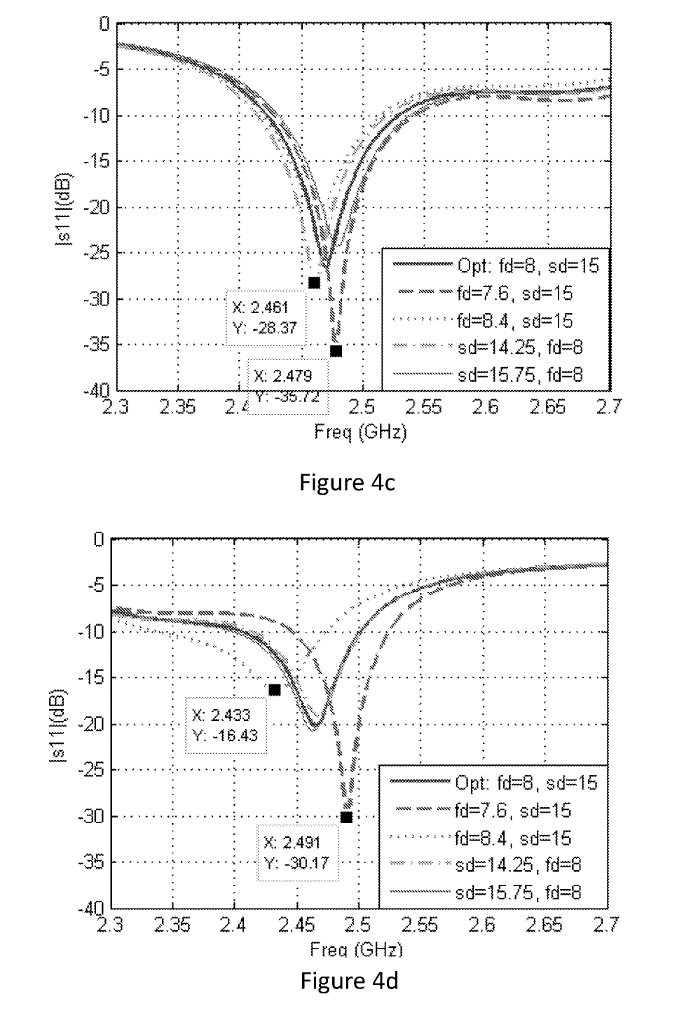

The described structure generates two modes, TM₀₀ and TM₀₁ as shown in FIG. 2b and FIG. 3b within the same frequency range. Both modes exist simultaneously but are not active at the same time. By changing the phase difference between the excitation points, the matching and the frequency of each mode are altered.

A first mode of operation is shown in FIGS. 2a and 2b. As shown in FIG. 2a, the shorter path 40 is selected for the first branch 34. The length of the second branch 36 is fixed. As shown in FIG. 2b, the first mode of operation is an omni-directional mode in which the radiation is directed in the horizontal plane of the antenna. There is minimal radiation in the vertical direction with respect to the plane of the antenna.

A second mode of radiation is shown in FIGS. 3a and 3b. As shown in FIG. 3a, the longer path 38 is selected for the first branch 34. Since the length of the second branch 36 is fixed, the phase difference in the input signal at the first excitation point and the second excitation point is different for the second mode of radiation. As seen in FIG. 3a the electric field vectors are in opposite directions at the excitation points. Therefore to activate the TM₀₁ mode, the inputs from the excitation points should be out of phase. That is the phase difference should be 180° to activate the off-body link. As shown in FIG. 3b, radiation is directed in the vertical direction with respect to the plane of the antenna. During off-body operation, the TM₀₀ mode is detuned and therefore resonates at a lower frequency band.

When the excitations are not out of phase, the TM₀₁ mode is deactivated and the TM₀₀ mode is tuned.

In the TM₀₀ mode, the length of the longer branch is at least λ/4 shorter than in the TM₀₁ mode. Therefore the phase difference is less than 90°. As the phase difference approaches 0°, the radiation becomes more uniform along the horizontal plane of the antenna.

For the on-body operation, there is minimal radiation in the vertical direction of the antenna which is a big advantage for on-body links. The energy is directed along the body so that the links between on-body devices are boosted. On the other hand, the antenna has a directive radiation pattern for off-body operation which is optimum for connecting to off-body gateways.

In an embodiment, when the shorter path 40 is chosen, the first branch 34 connecting to the first feeding pin 20 is 44 mm longer than the second branch 36 feeding the second feeding pin 22. When the long section 38 is chosen, the first branch 34 connecting to the first feeding pin 20 is 56 mm longer than the second branch 36 feeding the second feeding pin 22.

Parametric analysis has been performed in order to find the optimum dimensions for the antenna to operate at 2.4 GHz ISM band. The table below lists each parameter labelled in FIG. 1 and their optimum values.

| | | | |
|---|---|---|---|
| pl | patch length | 45 | mm |
| sl | substrate length | 50 | mm |
| fd | feeding distance | 8 | mm |
| sd | shorting pin distance | 15 | mm |
| pr | pin radius | 0.64 | mm |
| sr | slot radius | 0.9 | mm |

The parameterization is demonstrated here by having 5% variation from the optimum value of each dimension.

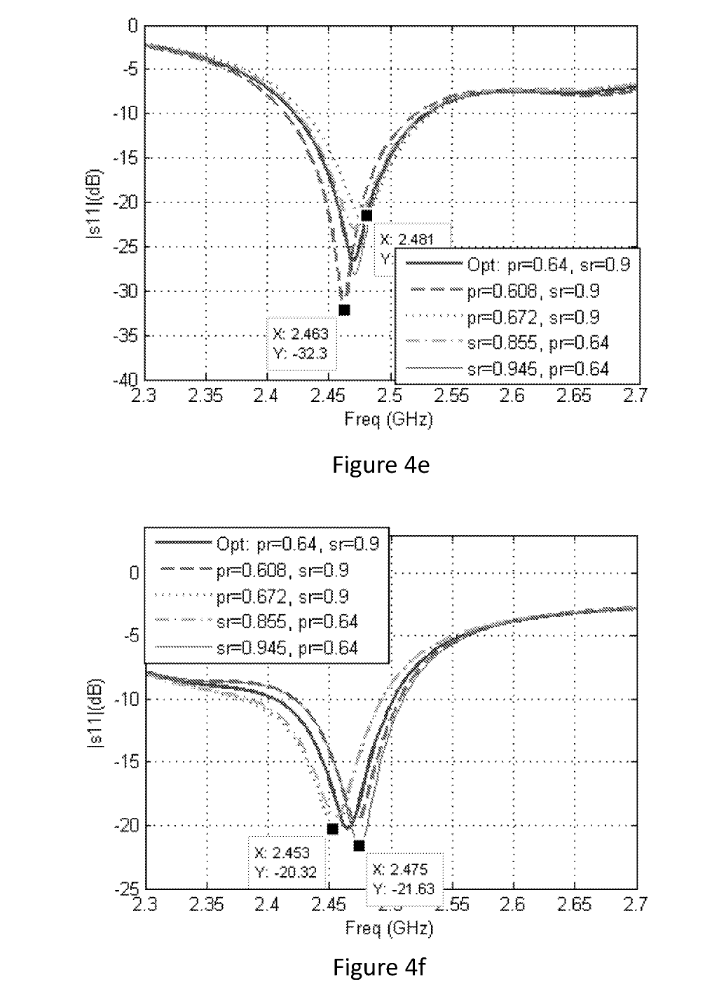

FIGS. 4a to 4f show the results of the parametric analysis. The values for the parameters pl, sl, fd, sd, pr and sr are all shown in mm. First of all, it can be seen that, none of these variations are substantial enough to completely detune any mode.

FIG. 4a shows the effect of varying the patch length (pl) and substrate length on the TM₀₀ mode. When the patch length (pl) is varied in the order of 5%, there is approximately 40 MHz shift in resonant frequency of TM₀₀ mode. A 5% change in substrate length (sl) also shifts the resonant frequency of the TM₀₀ mode while the outcome is more subtle, approximately 20 MHz shift.

FIG. 4b shows the effect of varying the patch length (pl) and substrate length on the TM₀₁ mode. A 5% change in patch length (pl) results in no significant change in the TM₀₁ mode's response. On the other hand, increase in the difference between the substrate length and patch length further isolates the modes.

FIG. 4c and FIG. 4d show the effects of changing the feed distance (fd) and shorting distance on the TM₀₀ mode and the TM₀₁ mode respectively. FIG. 4c and FIG. 4d show that the frequency response of the TM₀₁ mode can be tuned by changing the position of the feeding pins (fd) while minimally disturbing the TM₀₀ mode. Moving the feeding pins towards the centre by 5% of its optimum value, the resonant frequency of TM₀₁ is increased by 25 MHz.

FIG. 4e and FIG. 4f show the effects of changing the pin radius (pr) and slot radius on the TM₀₀ mode and the TM₀₁ mode respectively. Although 5% variation is not strong enough, it is visible that increasing the pin radius (pr) and decreasing the slot radius (sr) have almost the same effect on TM₀₁ mode and decreases its resonant frequency by 10 MHz. Moreover, increasing the pin radius in 5% increments shifts the resonant frequency of TM₀₀ mode up by 10 MHz while slot radius has no effect on TM₀₀ mode.

According to an embodiment, the antenna described above is used in body sensor network or body area network (BAN).

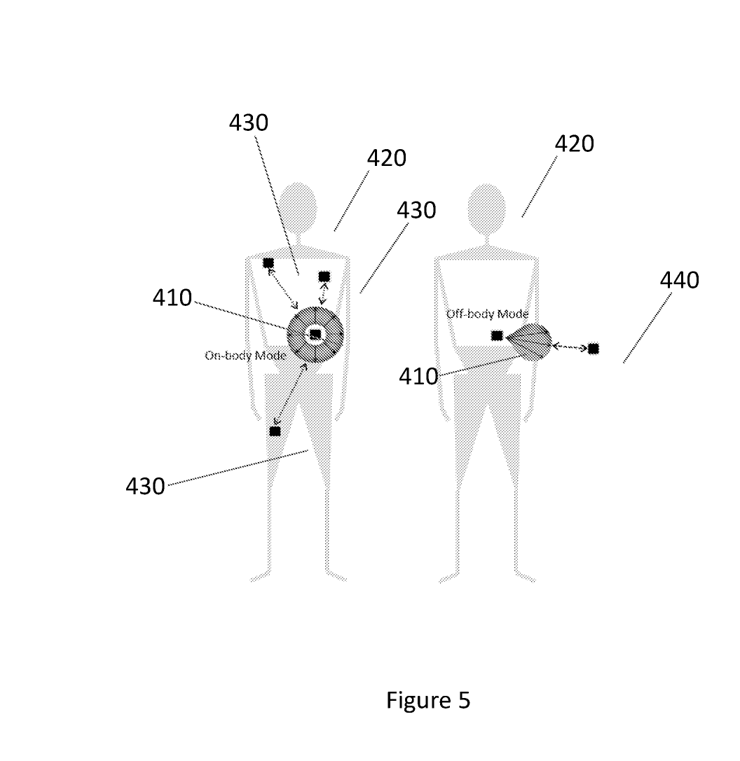

FIG. 5 shows a body area network incorporating a sensor or relay device which comprises an antenna as described above.

A relay device 410 is located on the body of a patient 420. A number of sensors 430 are also located on the patient 420. When operating in an on-body mode, the relay device 410 transmits and receives data from the sensors 430.

An off-body gateway 440 receives and transmits data to the relay device 410 when operating in an off-body mode.

The radiation pattern shown in FIG. 2b is used for the on-body mode. For the on-body mode of radiation, there is minimal radiation in the vertical direction which is a big advantage for on-body links. The radiation pattern shown in FIG. 3b is used for the off-body mode. The off-body mode is optimized for connecting to an off-body gateway while being isolated from the lossy body tissue.

In the embodiment shown in FIG. 1, the radiating plane and the ground plane are both square. In other embodiments, either or both of the radiating plane and the ground plane may be circular, rectangular or other planar shapes. In the embodiment shown in FIG. 1, the ground plane is larger than the radiating plane 12. In other embodiments the ground plane can be of the same size as the radiating surface, smaller or larger.

The substrate material and thickness (“h1”) controls the bandwidth of the structure. Assuming air between the conductors, 0.04λ thickness is needed for 4% bandwidth. The loss tangent of the substrate is the main source of loss impacting the radiation efficiency.

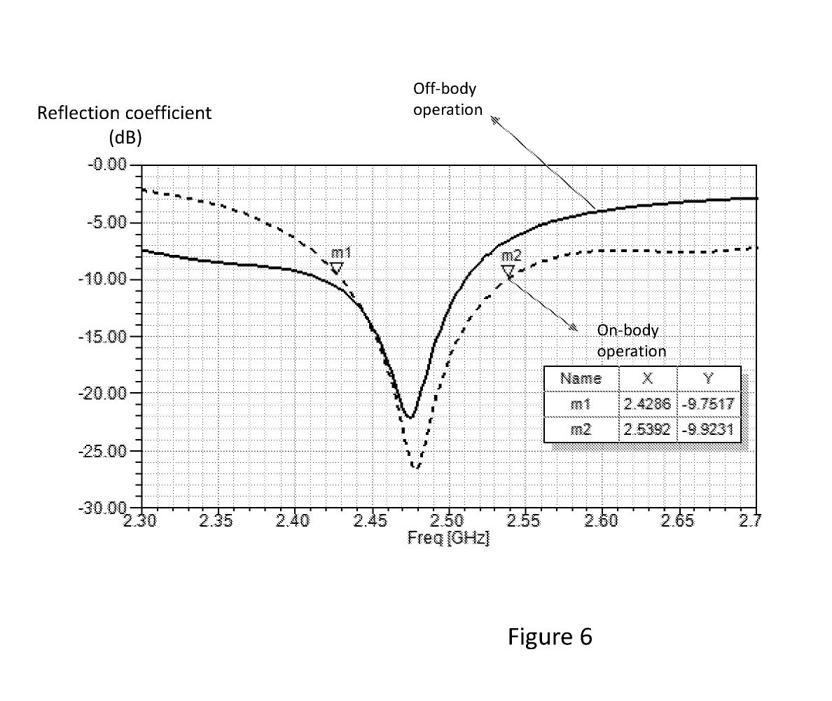

FIG. 6 shows the reflection coefficient versus frequency for an antenna operating in the 2.4 GHz ISM band. As shown in FIG. 6, there is a bandwidth of approximately 100 MHz in for the off-body mode and 120 MHz for the on-body mode.

Embodiments provide an antenna that is easy to manufacture with printed circuit board technology and can be realized in a single or double layer structure with single radiating element. Embodiments may be realised that are no bigger than a single mode on-body antenna.

In embodiments, the ground plane is arranged within the antenna. This provides improved isolation from the structure the antenna is embedded on.

An advantage of embodiments is that they realize both the omnidirectional mode and the directional mode at the same frequency utilizing a switching mechanism in a conformal structure.

Antennas according to embodiments can be positioned on top of any rf energy hostile half space and provide radiation diversity. For example, antennas according to embodiments can be installed in a vehicle body or under a roof, invisibly to a passer-by observer, for vehicular communications which has similar design parameters as on-body communications.

While certain embodiments have been described, these embodiments have been presented by way of example only and are not intended to limit the scope of the inventions. Indeed, the novel antennas described herein may be embodied in a variety of other forms; furthermore, various omissions, substitutions and changes in the form of the antennas described herein may be made without departing from the spirit of the inventions. The accompanying claims and their equivalents are intended to cover such forms or modifications as would fall within the scope and spirit of the inventions

1. An antenna comprising
a planar patch radiator having a first excitation point and a second excitation point;
a ground plane; and
a feed line configured to couple an input signal to the first excitation point and the second excitation point such that the relative phase between the input signal at the first excitation point and the input signal at the second excitation point is switchable between a first relative phase and a second relative phase and the antenna is operable to radiate in a first mode in response to the relative phase between the input signal at the first excitation point and the input signal at the second excitation point being the first relative phase and the antenna is operable to radiate in a second mode in response to the relative phase between the input signal at the first excitation point and the input signal at the second excitation point being the second relative phase.

2. An antenna according to claim 1, wherein the feed line comprises
a first branch coupled to the first excitation point;
a second branch coupled to the second excitation point; and
a switchable element configured to switch the feed line between a first configuration and a second configuration, wherein in the first configuration there is a first path difference between the first branch and the second branch and in the second configuration there is a second path difference between the first branch and the second branch.

3. An antenna according to claim 2,
wherein in the first configuration, the first mode is resonant at a frequency within an operating frequency band, whereas the second mode is resonant at a frequency outside the operating frequency band, and
wherein in the second configuration, the second mode is resonant at a frequency within the operating frequency band, whereas the second mode is resonant at a frequency outside the operating frequency band,
thereby forcing operation of the antenna in a mode dependent on configuration.

4. An antenna according to claim 1, wherein the ground plane is arranged between the planar patch radiator and the feed line.

5. An antenna according to claim 4, further comprising a first feeding pin connected to the first excitation point and a second feeding pin connected to the second excitation point, wherein the first feeding pin passes through a first slot in the ground plane and couples to the feed line and the second feeding pin passes through a second slot in the ground plane and couples to the feed line.

6. An antenna according to claim 1, wherein the first mode is an omni-directional mode in which the antenna radiates in the plane of the planar radiator and the second mode is a directive radiation mode in which the antenna radiates normal to the plane of the planar radiator.

7. An antenna according to claim 1, wherein the first excitation point and the second excitation point are symmetrical in the plane of the planar radiator.

8. An antenna according to claim 1 wherein the planar patch radiator and/or the ground plane is rectangular.

9. An antenna according to claim 8, wherein the size of the antenna in the plane of the planar radiator is less than 0.5 wavelengths of the input signal at the operating frequency by less than 0.5 wavelengths of the input signal at the operating frequency.

10. An antenna according to claim 8, wherein the planar patch radiator is rectangular and the sides of the planar patch radiator have a dimension in the range is 0.42 wavelengths of the input signal at the operating frequency to 0.34 wavelengths of the input signal at the operating frequency.

11. An antenna according to claim 1 wherein the planar patch radiator and/or the ground plane is circular.

12. An antenna according to claim 11, wherein the planar patch radiator is circular and has a diameter in the range 0.47 wavelengths of the input signal at the operating frequency to 0.40 wavelengths of the input signal at the operating frequency.

13. An antenna according to claim 1, configured for use in a body area network, wherein the first mode is an on body mode and the second mode is an off body mode.

14. An antenna according to claim 13, wherein the first relative phase generates a phase difference of less than 90 degrees and the second relative phase generates a phase difference of greater than 90 degrees.

15. An antenna according to claim 2 wherein the switchable element comprises a PIN diode, a MEMS switch or a MOSFET switch.
